(19) United States
(12) Patent Application Publication
(10) Pub. No.: US 2017/0309067 A1
(43) Pub. Date: Oct. 26, 2017

(54) PARTS PROCESSING ASSISTANCE SYSTEM AND METHOD

(71) Applicant: KAWASAKI JUKOGYO KABUSHIKI KAISHA, Kobe-shi, Hyogo (JP)

(72) Inventors: Naohiro NAKAMURA, Akashi-shi (JP); Shinichi NAKANO, Suita-shi (JP); Shigekazu SHIKODA, Akashi-shi (JP); Masahiko AKAMATSU, Himeji-shi (JP); Shingo YONEMOTO, Kakogawa-shi (JP)

(73) Assignee: KAWASAKI JUKOGYO KABUSHIKI KAISHA, Kobe-shi, Hyogo (JP)

(21) Appl. No.: 15/523,508

(22) PCT Filed: Oct. 29, 2015
(86) PCT No.: PCT/JP2015/080552

§ 371 Date: May 1, 2017

(30) Foreign Application Priority Data
Oct. 29, 2014 (JP) 2014-220723

(51) Int. Cl. G06T 17/10; G06T 7/246; G01B 21/04; G06F 3/042; G01C 11/26; H04N 13/02

(52) U.S. Cl. CPC G06T 17/10; G01B 21/047; G06F 3/0428; G06T 7/251; H04N 13/0242; G01C 11/26

(57) ABSTRACT

A parts processing assistance system includes a three dimensional measurement unit for acquiring a three dimensional measured data about a part, a display unit for displaying the part based on the three dimensional measured data, and a virtual assembly unit for virtually assembling the part displayed by the display unit on the display unit. According to this system, assembly error can be confirmed before an actual assembly work of parts.

### TECHNICAL FIELD

The present invention relates to a parts processing assistance system and method to assist parts processing work.

### BACKGROUND ART

Recently, in accordance with complication of products, assembly errors accumulate in an assembly process even after ensuring processing accuracy of a single part. As a result, the parts often cannot be assembled at the site. Particularly, this tends to occur in a large product.

If assembly is impossible at the side due to assembly errors, the parts need to be moved to a processing plant for modification and moved to the assembly plant again after the modification. Parts for a large product need to be moved using a crane or the like as they are heavy, and working hours and man-hours for that significantly increase.

Conventionally, in order to ensure processing accuracy of individual parts configuring a product, there is a method of acquiring three dimensional shape data of a processed part by a three dimensional scanner and comparing this three dimensional shape data with a CAD data of the part so as to confirm a deviation to a set value of the part.

Additionally, Patent Document 1 describes a technique that data of an item to be packed is acquired by a three dimensional scanner and packing materials for support to be arranged inside a packing box are automatically designed based on the acquired three dimensional shape data.

### CITATION LIST

### Patent Document

[Patent Document 1] Japanese Patent Application Laid-Open No. 2007-164257

### SUMMARY OF INVENTION

### Objects to be Achieved by the Invention

However, although the conventional method that three dimensional shape data of a part acquired by a three dimensional scanner is compared with a CAD data is effective for ensuring processing accuracy of individual parts, it cannot confirm assembly error when parts are actually assembled.

Additionally, the technique described in Patent Document 1 also cannot confirm assembly error when processed individual parts are assembled.

The present invention is made considering the above-stated problems of the conventional techniques, and its object is to provide a parts processing assistance system and method capable of confirming assembly error before an actual assembly work of parts.

### Means for Achieving the Objects

In order to achieve the objects above, a first aspect of the present invention is a parts processing assistance system for assisting a processing work of a part, comprising: a three dimensional measurement unit for acquiring a three dimensional measured data about the part; display unit for displaying the part based on the three dimensional measured data; and a virtual assembly unit for virtually assembling the part displayed by the display unit on the display unit.

A second aspect of the present invention is that, in the first aspect, a jig for acquiring a reference position upon a virtual assembly by the virtual assembly unit is provided to the part, and that the three dimensional measured data contains a data about the jig.

A third aspect of the present invention is that, in the second aspect, the jig is provided so as to extend on an axis line of a hole formed in the part.

A fourth aspect of the present invention is that, in the second aspect, the jig has three plane surfaces measured by the three dimensional measurement unit.

A fifth aspect is that, in any one of the first to fourth aspects, the three dimensional measured data is acquired by two or more different kinds of the three dimensional measurement unit.

A sixth aspect of the present invention is that, in the fifth aspect, the three dimensional measured data acquired by the two or more different kinds of the three dimensional measurement unit contains a data about a common measurement spot.

A seventh aspect of the present invention is that, in any one of the first to sixth aspects, the virtual assembly unit is configured to perform positioning of the part utilizing a design information as an ideal state, when virtually assembling the part displayed by the display unit on the display unit.

A eighth aspect of the present invention is that, in any one of the first to seventh aspects, the virtual assembly unit is configured to perform a virtual assembly utilizing a portion of data about the part, when virtually assembling the part displayed by the display unit on the display unit.

In order to achieve the objects above, a ninth aspect of the present invention is a parts processing assistance method for assisting a processing work of a part, comprising: a data acquiring process for acquiring a three dimensional measured data about the part; a display process for displaying the part on a display unit based on the three dimensional measured data; and a virtual assembly process for virtually assembling the part on the display unit.

A tenth aspect of the present invention is that, in the ninth aspect, a jig for acquiring a reference position upon a virtual assembly in the virtual assembly process is provided to the part, and that the three dimensional measured data contains a data about the jig.

A eleventh aspect of the present invention is that, in the tenth aspect, the jig is provided so as to extend on an axis line of a hole formed in the part.

A twelfth aspect of the present invention is that, in the tenth aspect, the jig has three plane surfaces measured by the three dimensional measurement unit.

A thirteenth aspect of the present invention is that, in any one of the ninth to twelfth aspects, the three dimensional measured data is acquired by two or more different kinds of the three dimensional measurement unit.

A fourteenth aspect of the present invention is that, in the thirteenth aspect, the three dimensional measured data acquired by the two or more different kinds of the three dimensional measurement unit contains a data about a common measurement spot.

A fifteenth aspect of the present invention is that, in any one of the ninth to fourteenth aspects, in the virtual assembly process, positioning of the part is performed utilizing a design information as an ideal state, when virtually assembling the part on the display unit.

A sixteenth aspect of the present invention is that, in any one of the ninth to fourteenth aspects, in the virtual assembly process, a virtual assembly is performed utilizing a portion of data about the part, when virtually assembling the part on the display unit.

### Effect of the Invention

By a parts processing assistance system and method according to the present invention, assembly error can be confirmed before an actual assembly work of parts.

### BRIEF DESCRIPTION OF THE DRAWINGS

FIG. 1 is a block diagram illustrating a schematic configuration of a parts processing assistance system according to one embodiment of the present invention.

FIG. 2 is a schematic diagram illustrating the schematic configuration of the parts processing assistance system in FIG. 1 together with an object to be measured.

FIG. 3 is a schematic diagram illustrating a parts processing assistance method using the parts processing assistance system in FIG. 1.

FIG. 4 is another schematic diagram illustrating the parts processing assistance method using the parts processing assistance system in FIG. 1.

FIG. 5 is a schematic diagram illustrating a variation of a positioning jig.

FIG. 6 is a schematic diagram illustrating enlarged positioning jig in FIG. 5.

FIG. 7 is a schematic diagram illustrating a method of using the positioning jig in FIG. 5 and FIG. 6.

FIG. 8 is another schematic diagram illustrating the method of using the positioning jig in FIG. 5 and FIG. 6.

FIG. 9 illustrates a method of performing positioning using design information (ideal situation) in the embodiment in FIG. 1.

FIG. 10 is a schematic diagram illustrating a method of utilizing only a part of data in a virtual assembly in the embodiment in FIG. 1.

FIG. 11 is another schematic diagram illustrating the method of utilizing only a part of data in a virtual assembly in the embodiment in FIG. 1.

### EMBODIMENT OF THE INVENTION

Hereunder, a parts processing assistance system and a parts processing assistance method according to one embodiment of the present invention will be described referring to the drawings.

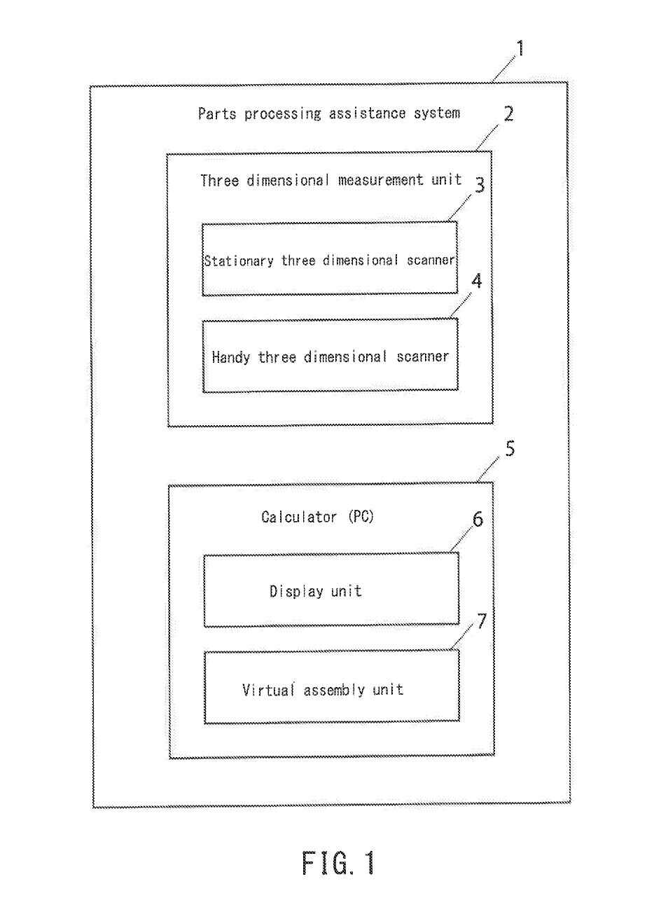

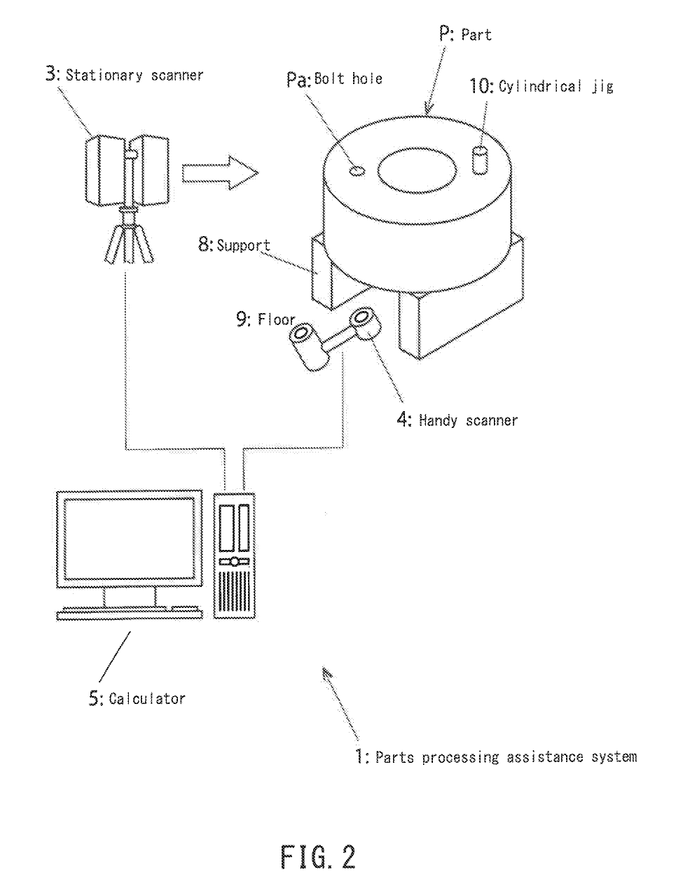

As illustrated in FIG. 1 and FIG. 2, a parts processing assistance system 1 according to this embodiment comprises a three dimensional measuring unit 2 for acquiring three dimensional data regarding a part configuring a product. A stationary three dimensional scanner 3 and a handy three dimensional scanner 4 are included in the three dimensional measuring unit 2.

Three dimensional shape data acquired by the respective three dimensional scanners 3, 4 are sent to a calculator (PC) 5 on-line or off-line. Note that the three dimensional shape data acquired by the three dimensional scanners 3, 4 are data regarding the shape of an object to be measured.

The calculator 5 configures a display unit 6 for displaying a part P as an object to be measured based on the measured three dimensional data acquired by the stationary three dimensional scanner 3 and the handy three dimensional scanner 4, and a virtual assembly unit 7 for virtually assembling a plurality of parts P which are displayed by the display unit 6 on the display unit 6.

Note that, the stationary three dimensional scanner 3 is used in a state of being placed on the floor surface or the like and it can acquire data at high speed, while it needs to ensure a certain distance from the object to be measured. On the other hand, the handy three dimensional scanner 4 can acquire data freely while a worker is carrying it, while it needs lots of time if the object to be measured is larger.

Accordingly, in the parts processing assistance system 1 according to this embodiment, considering the above-stated characteristics of the respective three dimensional scanners 3, 4, a side surface and a top surface of the part P are measured by the stationary three dimensional scanner 3, for example. On the other hand, the handy three dimensional scanner 4 measures a lower surface of the part P which cannot be measured by the stationary three dimensional scanner 3 due to limitation of height.

Then, the three dimensional shape data acquired by the respective three dimensional scanners 3, 4 are sent to a calculator 5 and the data acquired by the both scanners 3, 4 are combined and handled as one parts data.

Here, a common part is contained in the data to be combined in order to smoothly combine the three dimensional shape data acquired by the stationary three dimensional scanner 3 and the three dimensional shape acquired by the handy three dimensional scanner 4. Specifically, common measurement spots other than the part P which is a main object to be measured: for example, a support 8 and a floor surface 9 of the part P illustrated in FIG. 2 are measured in addition.

Since the three dimensional shape data acquired by the stationary three dimensional scanner contains data on the support 8 and the floor surface 9 of the part P, the three dimensional measured data of the both scanners 3, 4 can be combined smoothly utilizing the common data. Thereby, load of the calculator 5 can be reduced when combining the data of the stationary scanner 3 and the data of the handy scanner 4.

Note that, although the stationary three dimensional scanner 3 and the handy three dimensional scanner 4 are used in combination in this embodiment, a combination of the three dimensional measurement unit 2 is not limited to this and two or more different kinds of three dimensional measurement unit 2 whose measurement accuracy is different from each other can be combined.

Additionally, in this embodiment, a cylindrical jig 10 is provided to a bolt hole Pa of the part P to be measured such that it extends on the axis of the bolt hole Pa, as illustrated in FIG. 2. This cylindrical jig 10 is for acquiring a reference position of the bolt hole Pa upon virtual assembly by the virtual assembly unit 7, and it is provided to at least one of a plurality of parts P to be measured. Then, the three dimensional measurement unit 2 measures the part P, including a part of the cylindrical jig 10. Namely, the three dimensional measured data acquired by the three dimensional measurement unit 2 contains data about the cylindrical jig 10.

Next, a parts processing assistance method for assisting a processing work of the part P using the above-stated parts processing assistance system 1 will be described referring to the drawings.

First, three dimensional measured data of a plurality of parts P is acquired using the above-stated three dimensional measurement unit 2 (data acquiring process). The acquired three dimensional measured data is sent to the calculator 5 and a plurality of parts P are displayed on the display unit 6 based on the three dimensional measured data (display process).

Note that, as stated above, in the parts processing assistance system 1 according to this embodiment, the part P is measured by the stationary three dimensional scanner 3 and the handy three dimensional scanner 4 and the three dimensional measured data acquired by the both scanners 3, 4 are combined utilizing the data of common measurement spots.

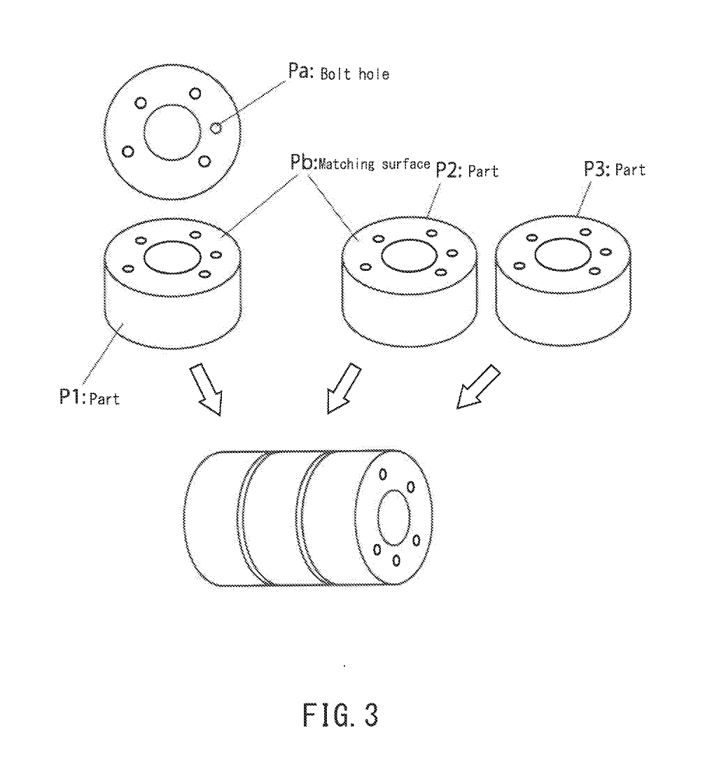

FIG. 3 illustrates a plurality of (three in this example) parts P1, P2, P3 displayed on the display unit 6 of the calculator 5. Each part P1, P2, P3 is a large part exceeding 10 m in diameter, for example. Each part P1, P2, P3 assumes a thick-walled disk shape having a center opening and a plurality of bolt holes Pa thorough which bolts for fastening the parts are inserted are formed in a circumference direction.

As illustrated in FIG. 2, the cylindrical jig 10 is used in order to surely acquire data of the axis of the bolt hole Pa of the part P1, P2, P3 using the three dimensional measurement unit 2. Thus, data of the axis of the bolt hole Pa can be surely acquired by measuring the cylindrical jig 10 which is arranged so as to extend on the axis line of the bolt hole Pa by the three dimensional measurement unit 2. When the axis of the bolt hole Pa is specified, the three dimensional shape data of the jig part is deleted, thereby obtaining parts data acquiring the axis of the bolt hole Pa.

When actually assembling the three parts P1, P2, P3, matching surfaces Pb of the respective parts are abutted to each other and also axes of the bolt holes Pa of the respective parts are aligned, and then the parts are fastened by bolts inserted through the bolt holes Pa.

In the parts processing assistance method according to this embodiment, a plurality of parts P1, P2, P3 are virtually assembled on the display unit 6 of the calculator 5 (virtual assembly process).

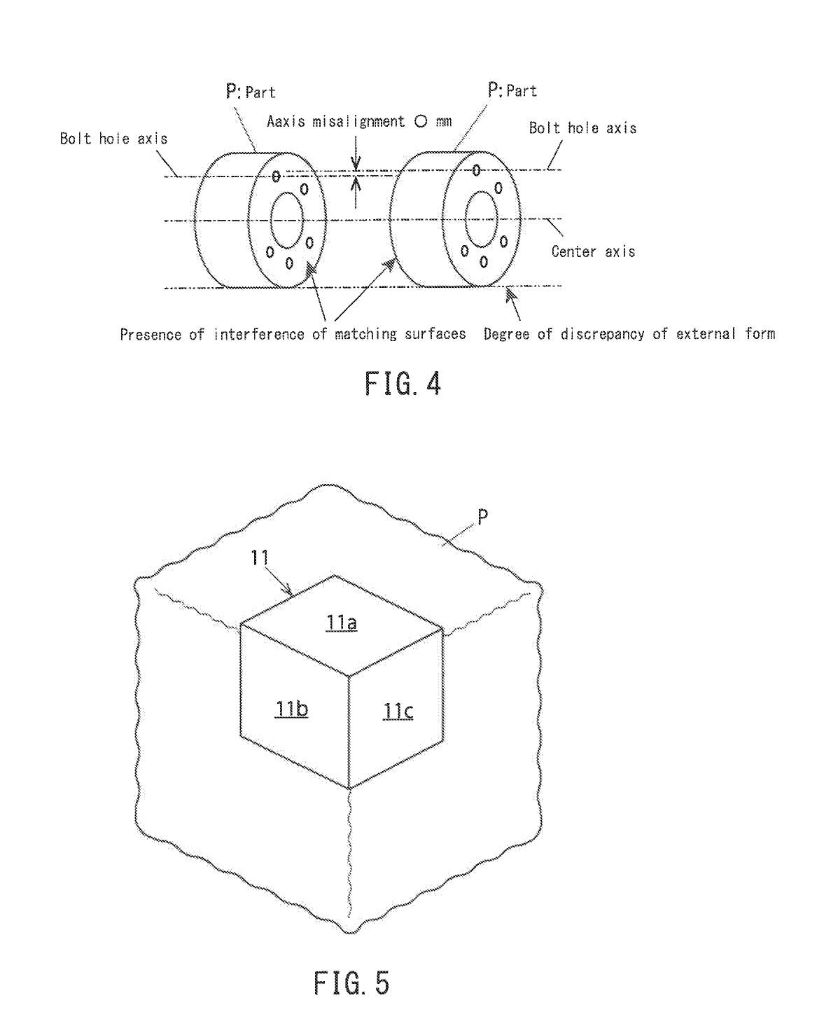

Then, as illustrated in FIG. 4, the parts P are virtually assembled on the basis of the center axis of the parts P, for example, and presence of interference of the matching surfaces Pb of the parts P, state of axis misalignment of the bolt holes Pa or degree of discrepancy of external forms of the parts P are confirmed on the display unit 6. Thereby, an assembly error when assembling a plurality of parts P can be confirmed beforehand without actually assembling the parts P.

If an unacceptable assembly error is confirmed by a virtual assembly on the display unit 6 of the calculator 5, the part P is applied correcting processing in the factory before conveying it to the site. Thereby, before an actual assembly at the site, an assembly error can be kept within an acceptable range and defects of assembly work at the site can be surely avoided.

Particularly, in the case of a large product, a work load for returning the parts P from the site to the factory is large and also temporary assembly itself sometimes cannot be performed in the factory since the product is too large. Therefore, benefits of preventing defects of assembly work at the site in advance is large.

Additionally, even in the case of a product which can be temporarily assembled in the factory, by using the parts processing assistance system 1 and method according to this embodiment, a temporary assembly does not need to be performed in the factory and correction after gauging actual stuff becomes unnecessary, thereby reducing time and man-hours so as to shorten the delivery time of the product.

Additionally, according to this embodiment, the parts P of a product which are shipped in a parts unit also do not need to be temporarily assembled in the factory.

Additionally, when an object to which the part P is assembled is fixed to equipment, temporary assembly cannot be performed in the factory. However, by virtually performing assembly using the parts processing assistance system 1 according to this embodiment, assembly error can be confirmed before actual assembly.

Note that, although the reference upon virtual assembly is the center axis of the part P in the above-stated embodiment, assembly reference is not limited to this and a processing surface of the part P, for example, can be assembly reference.

Additionally, although the jig 10 is provided into the bolt hole Pa in the above-stated embodiment, an installation position of a jig is not limited to the bolt hole Pa and a hole into which the jig is provided may be a through hole or a recessed portion. Additionally, a shape of the jig is not limited to a cylindrical shape and it is only needed to acquire three dimensional shape data which can specify the axis line of the hole.

Additionally, although the cylindrical jig 10 is used as a positioning jig in the above-stated embodiment, instead, or in addition to this, a positioning jig utilizing three place surfaces as stated below also can be used.

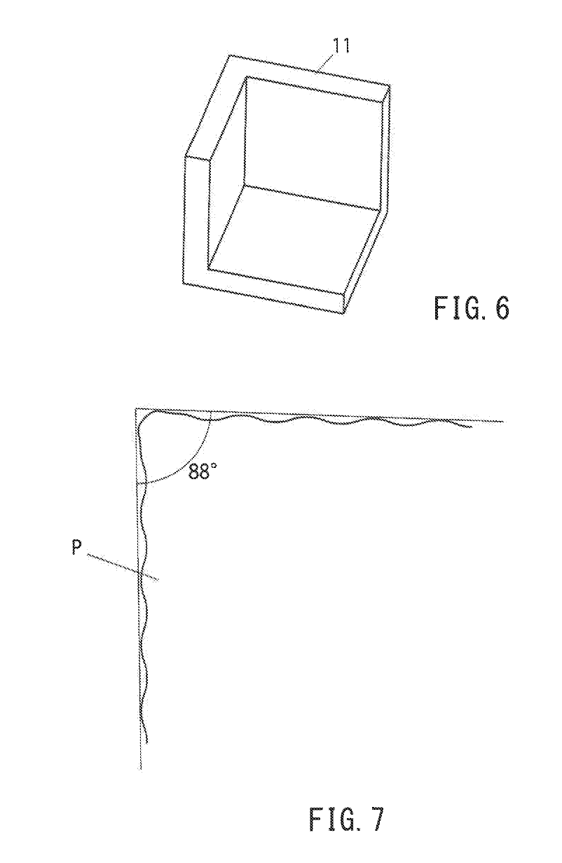

Thus, as illustrated in FIG. 5 and FIG. 6, this positioning jig 11 comprises three plane surfaces 11a, 11b, and 11c which can be measured by the three dimensional measurement unit 2 in a state of being mounted to the part P to be measured.

For example, when a surface of the part P has excessive roughness and an angle of the part P is not 90 degree (88 degree in this example) as illustrated in FIG. 7, sufficiently accurate measured data sometimes cannot be acquired if such spots are measured.

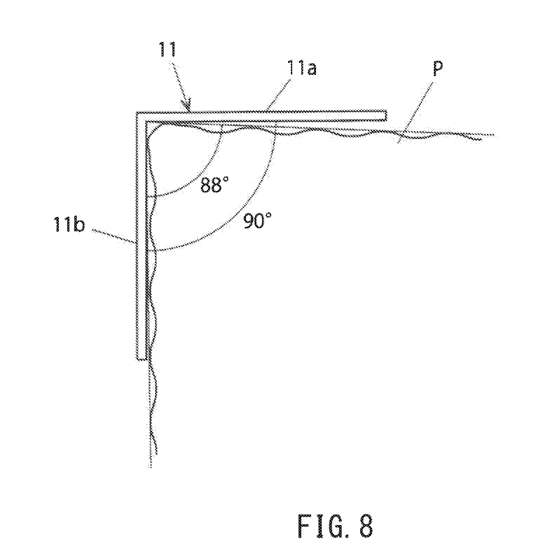

Accordingly, by mounting the positioning jig 11 to a corner of the part P as illustrated in FIG. 5 and FIG. 8, a plane surface as a measured object can be defined on the part P.

Additionally, as another variation, in the above-stated embodiment, positioning may be performed utilizing design information as an ideal state.

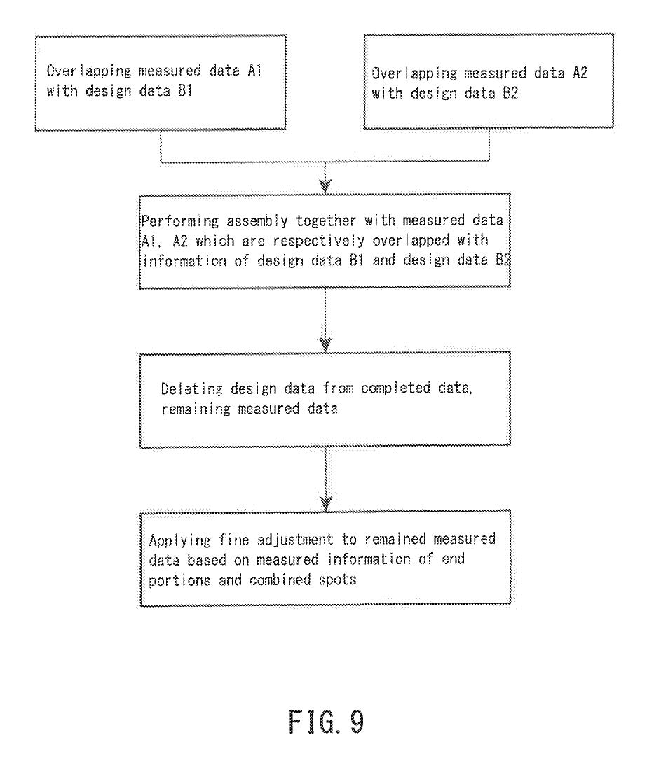

Thus, as illustrated in FIG. 9, a measured data A1 is overlapped with a design data B1 (S1). While, a measured data A2 is overlapped with a design data B2 (S2).

Next, assembly is performed together with the measured data A1, A2 which are respectively overlapped with information of the design data B1 and the design data B2 (S3). Subsequentially, the design data is deleted from the completed data, remaining the measured data (S4).

Finally, fine adjustment is applied to the remained measured data based on the measured information of end portions and combined spots. Since highly reliable positioning is already performed with the design information, the fine adjustment here is very small.

Additionally, as another variation, only a part of data may be utilized in the virtual assembly, in the above-stated embodiment.

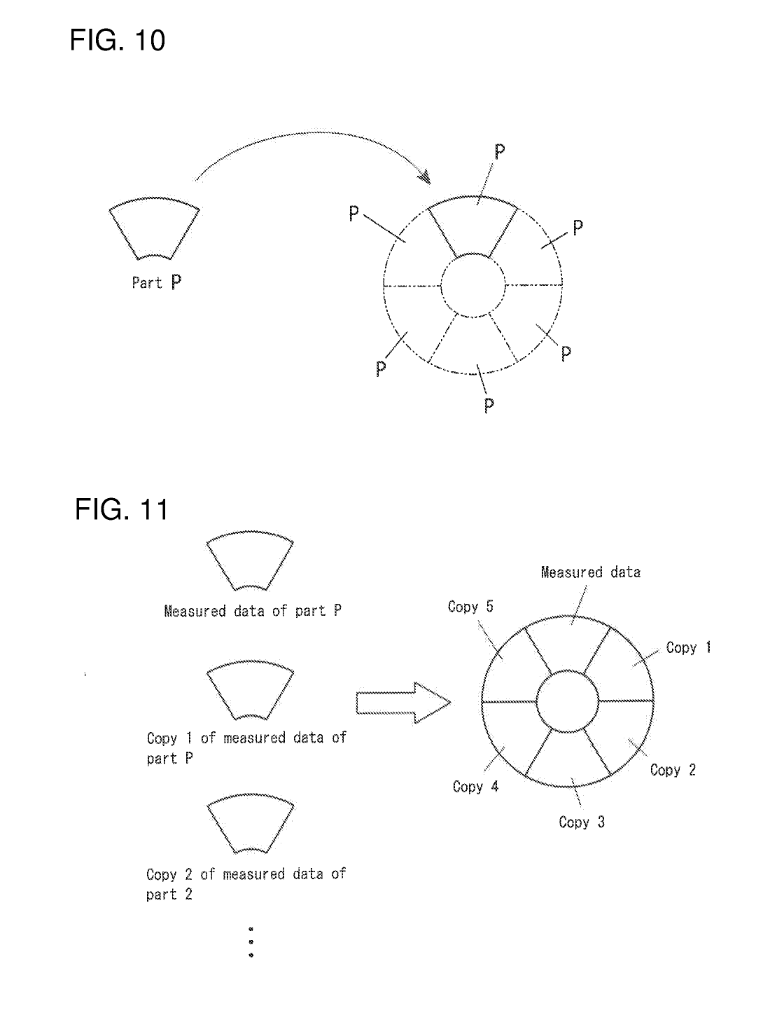

For example, as illustrated in FIG. 10, when an entire product is configured by a plurality of (six in this example) parts P having the same shape, the required number (five in this example) of measured data of the part P are copied, as illustrated in FIG. 11. Then, an entire completed shape is predicted by virtual assembly using a part of the measured data, and thus interference, etc. can be confirmed.

Additionally, even when a spot to be confirmed is limited, only a part of the measured data can be utilized. In this case, methods of deleting an unnecessary section from the measured data or not measuring the same from the beginning are considered.

Additionally, as another variation, a possible case when a plurality of three dimensional measurement unit are used in order to acquire the measured data to be utilized for virtual assembly is as follows.

For example, a metal processed surface is difficult to be measured by a contactless measurement instrument since light is irregularly reflected. Normally, measurement becomes possible by applying flaw detection agent, or the like so as to prevent the light to be irregularly reflected. However, cleaning is needed and such work is difficult, when there are many applicable spots.

In such a case, it is considered to use a contact measurement instrument for the metal processed surface. At this time, a part of the spot to be measured by the contactless measurement instrument is also measured by the contact measurement instrument for positioning.

### DESCRIPTION OF REFERENCE NUMERALS

1 . . . parts processing assistance system

2 . . . three dimensional measurement unit

3 . . . stationary three dimensional scanner

4 . . . handy three dimensional scanner

5 . . . calculator (PC)

6 . . . display unit

7 . . . virtual assembly unit

8 . . . support of part

9 . . . floor surface of factory

10 . . . cylindrical jig

11 . . . positioning jig haying three plane surfaces

P, P1, P2, P3 . . . part

Pa . . . bolt hole of part

Pb . . . matching surface of part

1. A parts processing assistance system for assisting a processing work of a part, comprising:
a three dimensional measurement unit for acquiring a three dimensional measured data about the part;
a display unit for displaying the part based on the three dimensional measured data; and
a virtual assembly unit for virtually assembling the part displayed by the display unit on the display unit.

2. The parts processing assistance system according to claim 1,
wherein a jig for acquiring a reference position upon a virtual assembly by the virtual assembly unit is provided to the part, and
wherein the three dimensional measured data contains a data about the jig.

3. The parts processing assistance system according to claim 2, wherein the jig is provided so as to extend on an axis line of a hole formed in the part.

4. The parts processing assistance system according to claim 2, wherein the jig has three plane surfaces measured by the three dimensional measurement unit.

5. The parts processing assistance system according to claim 1, wherein the three dimensional measured data is acquired by two or more different kinds of the three dimensional measurement unit.

6. The parts processing assistance system according to claim 5, wherein the three dimensional measured data acquired by the two or more different kinds of the three dimensional measurement unit contains a data about a common measurement spot.

7. The parts processing assistance system according to claim 1, wherein the virtual assembly unit is configured to perform positioning of the part by utilizing a design information as an ideal state when virtually assembling the part displayed by the display unit on the display unit.

8. The parts processing assistance system according to claim 1, wherein the virtual assembly unit is configured to perform a virtual assembly by utilizing a portion of data about the part when virtually assembling the part displayed by the display unit on the display unit.

9. A parts processing assistance method for assisting a processing work of a part, comprising:
a data acquiring process of acquiring a three dimensional measured data about the part;
a display process of displaying the part on a display unit based on the three dimensional measured data; and
a virtual assembly process of virtually assembling the part on the display unit.

10. The parts processing assistance method according to claim 9, wherein a jig for acquiring a reference position upon a virtual assembly in the virtual assembly process is provided to the part, and
wherein the three dimensional measured data contains a data about the jig.

11. The parts processing assistance method according to claim 10, wherein the jig is provided so as to extend on an axis line of a hole formed in the part.

12. The parts processing assistance method according to claim 10, wherein the jig has three plane surfaces measured by the three dimensional measurement unit.

13. The parts processing assistance method according to claim 9, wherein the three dimensional measured data is acquired by two or more different kinds of the three dimensional measurement unit.

14. The parts processing assistance method according to claim 13, wherein the three dimensional measured data acquired by the two or more different kinds of the three dimensional measurement unit contains a data about a common measurement spot.

15. The parts processing assistance method according to claim 9, wherein, in the virtual assembly process, positioning of the part is performed by utilizing a design information as an ideal state when virtually assembling the part on the display unit.

16. The parts processing assistance method according to claim 9, wherein, in the virtual assembly process, a virtual assembly is performed by utilizing a portion of data about the part when virtually assembling the part on the display unit.
